(19) United States
(12) Patent Application Publication
(10) Pub. No.: US 2020/0132052 A1
(43) Pub. Date: Apr. 30, 2020

(54) STRAIN AND VIBRATION MEASURING SYSTEM FOR MONITORING ROTOR BLADES

(71) Applicant: FOS4X GMBH, München (DE)

(72) Inventors: Markus SCHMID, Munich (DE); Lars HOFFMANN, Munich (DE)

(21) Appl. No.: 16/631,139

(22) PCT Filed: Jul. 12, 2018
(86) PCT No.: PCT/EP2018/069033

§ 371 Date: Jan. 14, 2020

(30) Foreign Application Priority Data
Jul. 14, 2017 (DE) 10 2017 115 927.4

(51) Int. Cl. F03D 17/00; F03D 7/02; G01M 5/00

(52) U.S. Cl. CPC F03D 17/00; F03D 7/0296; G01M 5/0091; G01M 5/0016; G01M 5/0066; G01M 5/0041

(57) ABSTRACT

The invention relates to an assembly for monitoring and/or controlling a wind turbine. The assembly for monitoring and/or controlling a wind turbine comprises: an arrangement of two strain sensors, in particular three strain sensors, which detects blade bending moments of a rotor blade of a wind turbine in at least two different spatial directions; a first fibre optic vibration sensor for detecting vibrations of the rotor blade in a first spatial direction; and at least one second fibre optic vibration sensor for detecting vibrations of the rotor in a second spatial direction, which differs from the first spatial direction.

### TECHNICAL FIELD

Embodiments of the present invention are generally related to controlling and/or regulating or monitoring the operation of wind turbines. Embodiments are in particular related to devices and methods including a strain and vibration measuring system.

### PRIOR ART

Wind turbines are subjected to a complex control or regulation, which may be required, for example, by changing operational conditions. Furthermore, measurements are necessary for monitoring the state of a wind turbine. Due to the conditions linked with the operation of a wind turbine, for example, temperature variations, weather and meteorological conditions, but also in particular strongly varying wind conditions, as well as due the multitude of safety measures prescribed by law, monitoring and the sensors necessary for monitoring are subjected to a plurality of constraints.

Rotor blades may be equipped with strain sensors, acceleration sensors or further sensors in order to detect blade loads, accelerations or further physical measurement parameters. The document US 2009/0246019 describes a measurement system comprised of four strain sensors in the blade root for ice detection. The document WO 2017/000960 A1 describes a method for measuring the load of a wind turbine and a wind energy plant for such a load measurement. Load sensors are configured to measure a mechanical deformation of the root end of the blade. Load sensors may be optical strain gauges such as e.g. fiber Bragg gratings. A triaxial acceleration sensor for blade state monitoring is described in WO 1999/057435.

In monitoring operational states of wind turbines, a plurality of sensors is used. Strain measurements for measuring the bending of a rotor blade, acceleration measurements for measuring an acceleration of the rotor blade, or other parameters may be measured, for example. One group of sensors seeming to promise success for further applications, are fiber optic sensors. It is therefore desirable to further improve measurements for monitoring a wind turbine with fiber optic sensors.

In general, it is therefore desirable to enable improvements in controlling and monitoring in sensors for a rotor blade of a wind turbine, in rotor blades for wind turbines, and in wind turbines themselves.

### SUMMARY OF THE INVENTION

According to one embodiment, an assembly for monitoring and/or controlling a wind turbine is provided. The assembly for monitoring and/or controlling a wind turbine includes an arrangement of at least two strain sensors, in particular three strain sensors, which detects blade bending moments of a rotor blade of a wind turbine in at least two different spatial directions; a first fiber optic vibration sensor for detecting vibrations of the rotor blade in a first spatial direction; and at least one second fiber optic vibration sensor for detecting vibrations of the rotor in a second spatial direction, which differs from the first spatial direction.

According to a further embodiment, a method for monitoring and/or controlling a wind turbine is provided The method includes measuring vibrations of a rotor blade of the wind turbine in two different spatial directions, wherein the measuring of vibrations is performed by means of at least two fiber optic vibration sensors; measuring bending moments of the rotor blade of the wind turbine in at least two different spatial directions; and monitoring and/or controlling the wind turbine based on the vibrations in the two different spatial directions of the measurement of vibrations, and the bending moments in the at least two different spatial directions of the measurement of bending moments.

### BRIEF DESCRIPTION OF THE DRAWINGS

Exemplary embodiments are shown in the drawings and explained in more detail in the description below. In the drawings:

FIG. 1 schematically shows a rotor blade of a wind turbine with sensors according to embodiments described herein;

FIG. 2 schematically shows a part of a wind turbine with rotor blades and sensors according to embodiments described herein;

FIG. 3 schematically shows a part of a wind turbine with sensors according to further embodiments described herein;

FIG. 4A schematically shows a cross-section of a rotor blade of a wind turbine with strain sensors;

FIG. 4B schematically shows a rotor blade of a wind turbine with sensors according to embodiments described herein;

FIG. 5 schematically shows an optical fiber with a fiber Bragg grating for use in vibration sensors according to embodiments described herein;

FIG. 6 schematically shows a measurement setup for a fiber optic vibration sensor according to embodiments described herein or for methods for monitoring and/or controlling and/or regulating according to embodiments described herein; and

FIG. 7 shows a flow chart of a method for monitoring and/or controlling and/or regulating wind turbines according to embodiments described herein.

In the drawings, identical reference numerals denote identical or functionally identical components or steps.

### MODES FOR CARRYING OUT THE INVENTION

Hereinafter, more detailed reference is made to various embodiments of the invention, with one or more examples being illustrated in the drawings.

Wind turbines can be monitored and regulated by measurement technological systems in the rotor blades. Hereby, one or more of the following applications may be implemented: individual pitch control of a rotor blade, buoyancy optimization of a rotor blade, load regulation of a rotor blade or the wind turbine, load measurement on a rotor blade or the wind turbine, determination of the state of components of the wind turbine, for example, determination of the state of a rotor blade, ice detection, lifetime estimation of components of the wind turbine, for example, a rotor blade, regulation based on wind fields, regulation based on trailing effects of the rotor, regulation based on loads, regulation of the wind turbine with respect to adjacent wind turbines, predictive maintenance, tower clearance measurement, peak load switch-off, and detection of imbalance.

Embodiments of the present invention are related to a combination of strain and vibration sensors in the rotor blade of a wind turbine. Here, it is possible to obtain a complete image on the blade load and vibration of a rotor blade of a wind turbine, wherein an optimized relationship between redundancy of components and material usage (CoO=cost of ownership) can be achieved. Furthermore, there is the option of new applications for optimizing wind turbines.

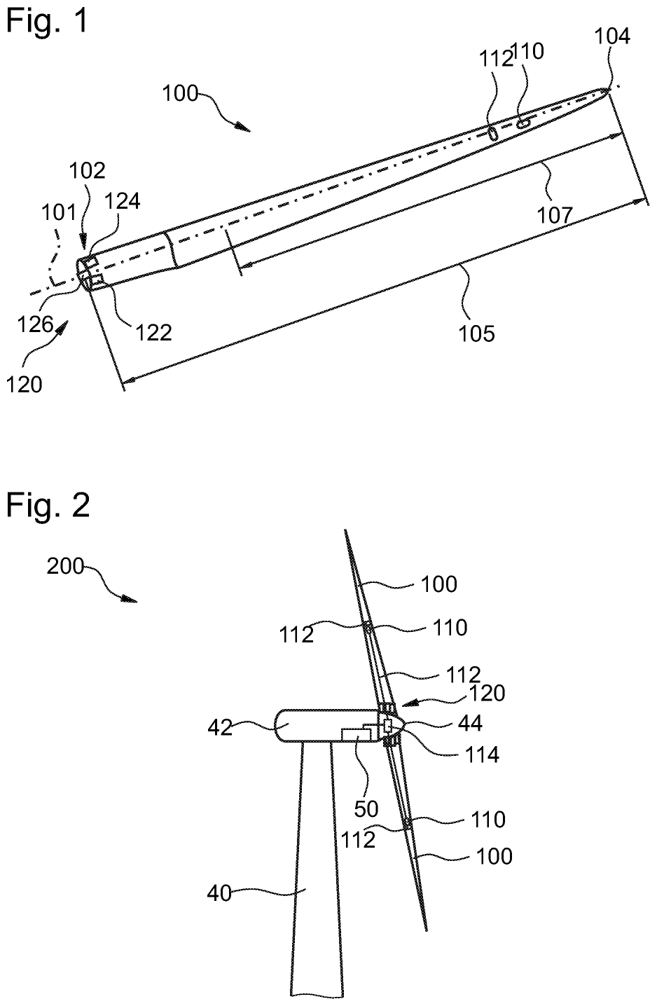

FIG. 1 shows a rotor blade 100 of a wind turbine. The rotor blade 100 has an axis 101 along its longitudinal extension. The length 105 of the rotor blade reaches from the blade flange 102 or blade root to the blade tip 104. According to embodiments described herein, in an axial or radial area, i.e. an area along the axis 101, a vibration sensor 110 and a vibration sensor 112 are located. The vibration sensor 110, i.e. a first vibration sensor detects vibrations in a first spatial direction, and the vibration sensor 112, i.e. a second vibration sensor detects vibrations in a second spatial direction, which differs from the first spatial direction. Further vibration sensors can be provided, for example, for the purpose of redundancy, for measuring in the first and/or second spatial direction(s). The first spatial direction may be, for example, the swing direction of a rotor blade, i.e. the direction from the blade front edge to the blade rear edge. The second spatial direction may be the flapping direction of a rotor blade, i.e. the direction perpendicular to the swing direction. According to embodiments described herein, the first spatial direction and the second spatial direction can enclose an angle of 70° to 90°.

According to further embodiments, the vibration sensors may preferably be arranged in an area radially directed outward, i.e. toward the blade tip. The vibration sensors can be provided, for example, at a radial position in the area of the outer 80% to the outer 60% of the radius of a rotor blade of the wind turbine, as shown by the area 107 in FIG. 1.

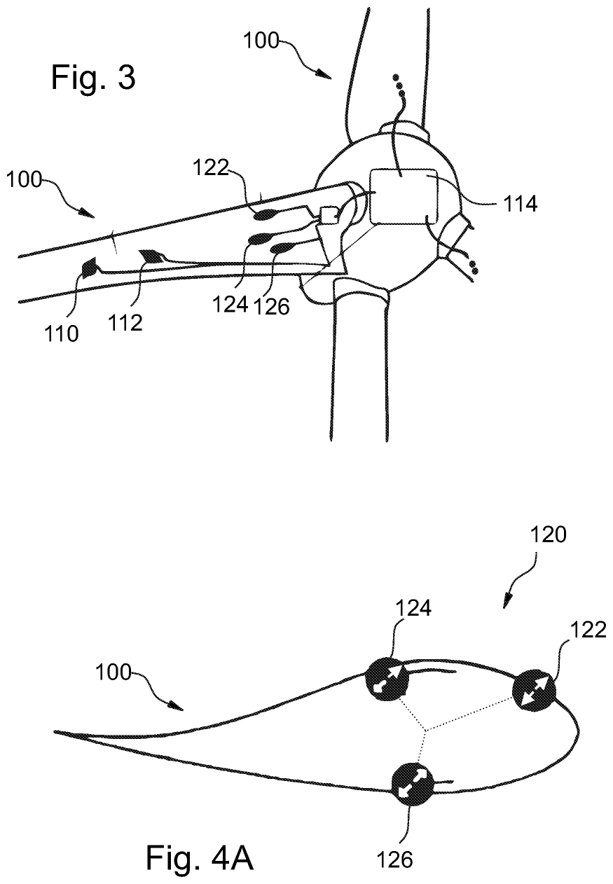

According to embodiments described herein, an arrangement of sensors in an area facing the blade tip is in particular enabled by the use of fiber optic sensors, for example, fiber optic vibration sensors. Fiber optic sensors can be provided without electrical components. This allows to avoid that a lightning strike takes place directly into electronic components and/or cables or signal cables for electronic components. Even in case of conducting a lightning strike via an arrester, i.e. in case of controlled conducting to ground potential, a damage in cables or signal cables by the currents generated by induction can be prevented. According to embodiments described herein, fiber optic vibration sensors are preferably used as will be explained in more detail with reference to FIG. 3.

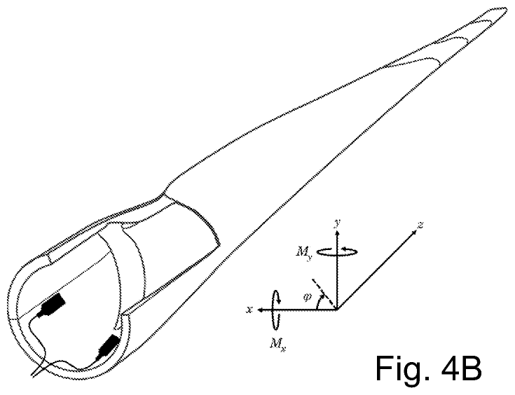

FIG. 1 furthermore shows an arrangement 120 of strain sensors or strain gauges. The arrangement 120 includes a first strain sensor 142, a second strain sensor 124 and a third strain sensor 126. According to some embodiments, the third strain sensor may be raged as being optional. This arrangement will be explained in more detail with reference to FIGS. 3 and 4. The arrangement of three strain sensors can detect two different spatial directions. By azimuthally placing three strain sensors, the blade bends or blade bending moments are detected in two spatial directions, for example, the flapping direction and the edge direction. According to typical embodiments, the three strain sensors may be provided at different angle coordinates along the longitudinal extension of the rotor blade in the coordinate system of a rotor blade. The one or more of the three different spatial directions may differ from one of the first spatial direction of a vibration sensor or the second spatial direction of a vibration sensor or may coincide with one of the first spatial direction of a vibration sensor or the second spatial direction of a vibration sensor.

FIG. 2 shows a wind turbine 200. The wind turbine 200 includes a tower 40 and a nacelle 42. The rotor is attached to the nacelle 42. The rotor includes a hub 44 to which the rotor blades 100 are attached. According to typical embodiments, the rotor has at least two rotor blades, in particular three rotor blades. During the operation of the wind turbine, the rotor, i.e. the hub together with the rotor blades, rotates about an axle. In doing so, a generator is driven for generating electricity. As illustrated in FIG. 2, two vibration sensors are provided in a rotor blade 100. By means of one signal line or signal lines, the vibration sensors are connected to an evaluation unit 114. Furthermore, a rotor blade includes an arrangement 120 of strain sensors. The evaluation unit 114 delivers a signal to a controller and/or regulation unit 50 of the wind turbine 200.

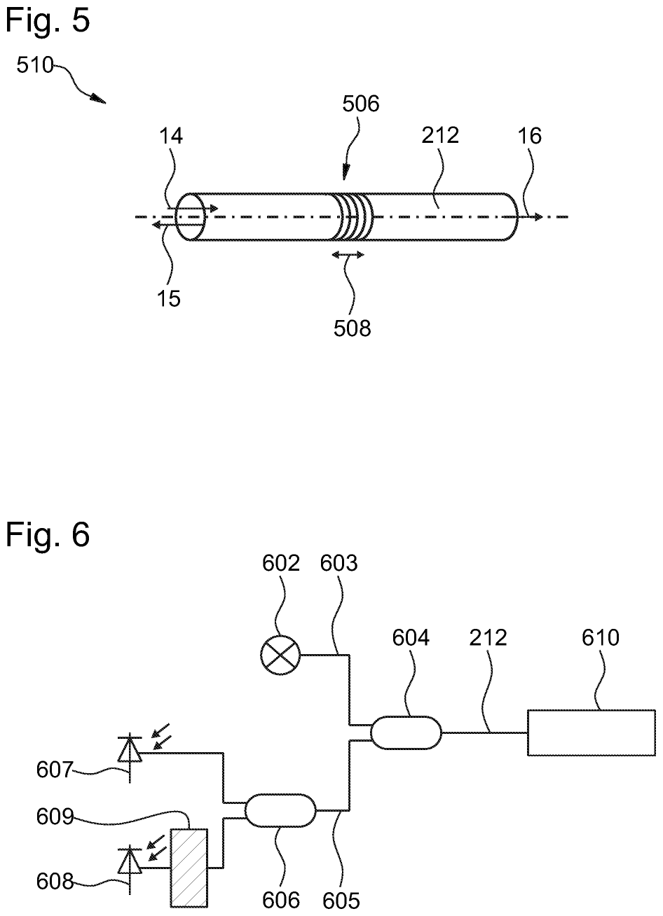

According to some embodiments, which can be combined with other embodiments, the vibration sensors (110/112) are fiber optic vibration sensors. For fiber optic vibration sensors, an optical signal is transmitted to the evaluation unit 114 by means of a light guide 212, for example, an optical fiber. In a fiber optic vibration sensor, the sensor element itself can be provided outside an optical fiber. As an alternative to this, the actual sensor element can be provided inside an optical fiber, for example, in the form of a fiber Bragg grating, in a fiber optic vibration sensor. This will be described in detail with reference to FIGS. 5 and 6.

The embodiments and applications mentioned above may be enabled by a combination of strain sensors and vibration sensors in the rotor blade. According to embodiments described herein, three strain sensors and two vibration sensors are used as is illustrated in FIG. 3. For determining the blade loads, the strain sensors are utilized which are arranged such that the blade bending moments are optimally reproduced in the flapping direction and swing direction.

The use of three strain sensors allows redundancy and thus increased safety against failures to be realized. According to embodiments described herein, it is moreover possible to use temperature-compensated strain sensors, in particular temperature-compensated fiber optic strain sensors. The use of temperature-compensated strain sensors allows the temperature influence on the determination of the blade bending moments to be minimized. Fiber optic strain sensors moreover enable high reliability of the blade bending moment determination due to their high peak load resistance and steady load resistance.

Vibration sensors in the rotor blade allow vibrations of the rotor blade to be determined, and thus applications, e.g. for blade state monitoring or ice detection, to be realized. The use of passive fiber optic sensors enables blade vibration without influence by electromagnetic fields or high electrical currents, such as e.g. lightning flashes, to be measured reliably.

FIG. 3 shows a part of a wind turbine, wherein sections of three rotor blades 100 are illustrated. An arrangement of a first strain sensor 122, a second strain sensor 124, and a third strain sensor 126 is in each case provided in a rotor blade. According to embodiments described herein, a first vibration sensor 110 and a second vibration sensor 112 are provided. The signals of the sensors are provided to an evaluation unit 114, for example, via a transmission unit 314.

The combination of measuring strain and vibration in the rotor blade enables the applications mentioned above. Moreover, the combination of the signals allows a more extensive view to be gained on the state and the operation of the wind turbine, whereby further applications may result. A complete view on the blade load and vibration of a rotor blade of a wind turbine can be provided. The result will be the option of realizing new applications for optimizing wind turbines. Embodiments of the present invention are related to the combination presented here of strain and vibration sensors in the rotor blade of a wind turbine. The use of two vibration sensors and three strain sensors allows a favorable relationship between material expenditure and redundancy to be provided.

According to some of the embodiments described herein, vibration sensors, in particular fiber optic vibration sensors, may be configured to measure a shift of vibration frequency. For example, a vibration sensor may not refer to absolute accelerations or measurements in frequency ranges. This may take place in the scope of an evaluation or by a corresponding analysis of optical fibers of a fiber optic vibration sensor, for example. According to further embodiments, vibration sensors may cover a frequency range from 0.1 Hz up to higher frequencies. A high-pass filter may be used, for example, in order to filter absolute accelerations occurring due to the rotation of the rotor from the signal.

According to some embodiments described herein, which can be combined with other embodiments, fiber optic vibration sensors and/or strain sensors enable measurements for monitoring the applications described herein. Furthermore, the fiber optic sensors allow risks in case of lightning strike to be reduced, and an optical transmission can reduce the maintenance expenditure.

FIG. 4A shows a cross-section of a rotor blade 100 and an arrangement of three strain sensors, wherein the strain sensors may be attached in the blade root or near the blade root, for example. According to some embodiments described herein, the three strain sensors may be attached in an angular grid of about 120°, with a deviation of ±20°, in particular ±10° being possible. Ideally, an azimuthal angular grid of 120° is used for covering the blade coordinate system. The azimuthal angle may be related to the coordinates in the blade root, for example, with a center point axis in parallel to the length of the rotor blade. This means that the azimuthal angle is related to a coordinate system of the rotor blade.

In general, the blade bending moments can be determined by two strain sensors, for example, in the flapping direction and swing direction. According to the IEC 61400-13 standard, the blade strains are determined by means of four strain sensors. If the survival probabilities of a strain sensor are regarded statistically, three strain sensors will result in a significant increase of the survival probability of the entire system as compared to a system with two strain sensors. A further increase of the survival probability of the entire system by four sensors, however, is correspondingly low. An arrangement 120 of three strain sensors for determining blade bending moments of a rotor blade of a wind turbine thus offers a similarly high survival probability of the entire system for determining blade bending moments at reduced material expenditure and thus reduced CoO. At the same time, three strain sensors allow the centripetal forces and constant components of temperature effects to be compensated for. According to typical embodiments, the strain sensors may be fiber optic strain sensors. Moreover, it is possible to use temperature-compensated fiber optic sensors.

The embodiments and applications described above can be enabled by a combination of strain sensors and vibration sensors. According to some embodiments described herein, two strain sensors can also be used as shown in FIG. 4B. For determining the blade loads, the strain sensors are utilized, which are arranged such that the blade bending moments in the flapping and swing direction are reproduced in an optimum way.

According to some embodiments, and as illustrated in FIG. 4A, for example, a further strain sensor may be provided in the rotor blade. The use of three strain sensors allows redundancy and thus increased safety against failures to be realized. According to embodiments described herein, it is moreover possible to use temperature-compensated strain sensors, in particular temperature-compensated fiber optic strain sensors. The use of temperature-compensated strain sensors allows the temperature influence on the determination of the blade bending moments to be minimized. Fiber optic strain sensors moreover enable high reliability of the blade bending moment determination due to their high peak load resistance and steady load resistance.

According to embodiments described herein, and as illustrated in FIG. 4B by way of example, two strain sensors are installed in the blade root 102 for determining the blade bending moments in the flapping and swing directions. A first strain sensor 122 can measure a bending moment in the X direction. A second strain sensor 124 can measure a bending moment in the Y direction. The strain sensors will be arranged such as to be, in the ideal case, azimuthally orthogonal to one another and thus cover the coordinate system of the rotor blade in the flapping and swing directions in an optimum way.

FIG. 5 shows a sensor or fiber optic sensor 510 integrated into an optical waveguide and featuring a fiber Bragg grating 506. Although only one single fiber Bragg grating 506 is shown in FIG. 5, it is to be understood that the present invention is not restricted to acquire data from a single fiber Bragg grating 506, but that a plurality of fiber Bragg gratings 506 can be arranged along a light guide 212, a transmission fiber, a sensor fiber or an optical fiber.

FIG. 5 thus only shows a portion of an optical waveguide formed as a sensor fiber, an optical fiber or a light guide 212, wherein this sensor fiber is sensitive to fiber strain (see arrow 508). It should be noted at this point that the expression “optical” or “light” is intended to indicate a wavelength range in the electromagnetic spectrum, which can extend from the ultraviolet spectral range via the visible spectral range up to the infrared spectral range. An average wavelength of the fiber Bragg grating 506, i.e. a so-called Bragg wavelength AB is obtained by the following equation:

λB=2·nk·Λ.

In this case, nk is the effective refractive index of the basic mode of the core of the optical fiber, and Λ is the spatial grating period (modulation period) of the fiber Bragg grating 506.

A spectral width given by the full width at half maximum of the reflection response depends on the expansion of the fiber Bragg grating 506 along the sensor fiber. Due to the effect of the fiber Bragg grating 506, light propagation within the sensor fiber or the light guide 212, for example, is dependent on forces, moments and mechanical tensions and temperatures applied to the sensor fiber, i.e. the optical fiber, and in particular the fiber Bragg grating 506 within the sensor fiber.

As shown in FIG. 5, electromagnetic radiation 14 or primary light enters the optical fiber or the light guide 112 from the left, with a part of the electromagnetic radiation 14, as transmitted light 16, exiting with a wavelength progress that is changed as compared to the electromagnetic radiation 14. Furthermore, it is possible for reflected light 15 to be received at the input end of the fiber (i.e. at the end, where the electromagnetic radiation 14 is also irradiated), with the reflected light 15 likewise featuring a modified wavelength distribution. According to the embodiments described herein, the optical signal used for detecting and evaluating may be provided by the reflected light, by the transmitted light, and a combination of both of them.

In a case, where the electromagnetic radiation 14 or the primary light is irradiated in a wide spectral range, a transmission minimum will result in the transmitted light 16 at the place of the Bragg wavelength. In the reflected light, a reflection maximum will result at this place. Detecting and evaluating the intensities of the transmission minimum or the reflection maximum, or of intensities in corresponding wavelength ranges, will generate a signal, which can be evaluated with respect to the length change of the optical fiber or the light guide 112 and is thus indicative of the forces or vibrations.

FIG. 6 shows a typical measurement system for detecting vibration by means of a device for detecting vibrations according to the embodiments described herein. The system includes one or more vibration sensors 110/112. The system features a source 602 of electromagnetic radiation, for example, a primary light source. The source serves for providing optical radiation, by means of which at least one fiber optic sensor element of a vibration sensor can be irradiated. For this purpose, an optical transmission fiber or a light guide 603 is provided between the primary light source 602 in a first fiber coupler 604. The fiber coupler couples the primary light into the optical fiber or the light guide 112. The source 602 may be, for example, a broadband source of light, a laser, an LED (light emitting diode), an SLD (superluminescent diode), an ASE source of light (amplified spontaneous emission source of light) or an SOA (semiconductor optical amplifier). Several sources of the same or a different type (see above) may also be used for embodiments described herein.

The fiber optic sensor element 610 such as a fiber Bragg grating (FBG) or an optical resonator, for example, is integrated into a sensor fiber or optically coupled to the sensor fiber. The light reflected from the fiber optic sensor elements is in turn guided via the fiber coupler 604, which guides the light via the transmission fiber 605 to a beam splitter 606. The beam splitter 606 splits the reflected light for detection by means of a first detector 607 and a second detector 608. On this occasion, the signal detected on the second detector 608 is first filtered by means of an optical edge filter 609.

The edge filter 609 allows a shift of the Bragg wavelength at the FBG or a wavelength change due to the optical resonator to be detected. In general, a measurement system as illustrated in FIG. 6 may be provided without the beam splitter 606 or the detector 607. The detector 607, however, enables the measurement signal of the vibration sensor to be standardized with respect to other intensity fluctuation, such as fluctuations in the intensity of the source 602, fluctuations by reflections in interfaces between individual light guides, or other intensity fluctuations, for example. This standardization improves the measurement accuracy and reduces the dependence of measurement systems on the length of the light guides provided between the evaluation unit and the fiber optic sensor.

In particular when several FBGs are used, additional optical filter means (not shown) may be provided for filtering the optical signal or secondary light. An optical filter means 609 or additional optical filter means may comprise an optical filter selected from the group consisting of a thin film filter, a fiber Bragg grating, an LPG, an arrayed waveguide grating (AWG), an Echelle grating, a grating array, a prism, an interferometer and any combination thereof.

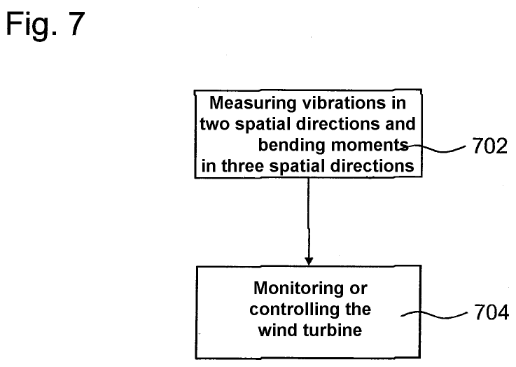

A further aspect in monitoring wind turbines, which can be combined with other embodiments and aspects described herein, but which is also provided independently of further embodiments, aspects and details, is an improved method for monitoring and controlling and/or regulating a wind turbine by means of vibration sensors and strain sensors, in particular fiber optic vibration sensors and fiber optic strain sensors. One or more of the following applications may be implemented: individual pitch control of a rotor blade, buoyancy optimization of a rotor blade, load regulation of a rotor blade or the wind turbine, load measurement on a rotor blade or the wind turbine, determination of the state of components of the wind turbine, for example, determination of the state of a rotor blade, ice detection, lifetime estimation of components of the wind turbine, for example, a rotor blade, regulation based on wind fields, regulation based on trailing effects of the rotor, regulation of the wind turbine based on loads, regulation of the wind turbine with respect to adjacent wind turbines, predictive maintenance, tower clearance measurement, peak load switch-off, and detection of imbalance. According to such an aspect or such an embodiment, a method for monitoring or controlling and/or regulating a wind turbine is provided. The method for monitoring a wind turbine includes measuring vibrations with two vibration sensors in two spatial directions and measuring bending moments in at least two different spatial directions, for example, three different spatial directions (see reference numeral 702 in FIG. 7). In particular, the measurement of vibrations may include measuring frequency shifts of vibrations. Furthermore, in particular, the measurement of vibrations may be configured such that for the signals relevant for regulating or controlling and/or state monitoring, a measurement of absolute accelerations and/or measurements in frequency ranges is/are not performed. For regulating or controlling and/or determining the state of the wind turbine, only a frequency shift is determined based on the vibration sensors. According to embodiments described herein, the signals for monitoring or regulating, in particular for one of the applications mentioned above, are used as shown by reference numeral 704.

Although the present invention has been described above on the basis of typical embodiments, it is not restricted thereto but can be modified in a number of ways. The invention is not restricted to the mentioned options of application either.

1. An assembly for at least one of monitoring and controlling a wind turbine, comprising:
an arrangement of at least two strain sensors, which detects blade bending moments of a rotor blade of a wind turbine in at least two different spatial directions;
a first fiber optic vibration sensor for detecting vibrations of the rotor blade in a first spatial direction; and
at least one second fiber optic vibration sensor for detecting vibrations of the rotor blade in a second spatial direction, which differs from the first spatial direction.

2. The assembly according to claim 1, wherein the first spatial direction and the second spatial direction enclose an angle of 70° to 110°.

3. The assembly according to claim 1, wherein three strain sensors are provided, and the three strain sensors are arranged in an azimuthal angular grid of about 120°.

4. The assembly according to claim 1, wherein the at least two strain sensors are fiber optic strain sensors.

5. A rotor blade of a wind turbine, comprising:
an assembly for at least one of monitoring and controlling a wind turbine, comprising:
an arrangement of at least two strain sensors, which detects blade bending moments of a rotor blade of a wind turbine in at least two different spatial directions;
a first fiber optic vibration sensor for detecting vibrations of the rotor blade in a first spatial direction; and
at least one second fiber optic vibration sensor for detecting vibrations of the rotor blade in a second spatial direction, which differs from the first spatial direction.

6. The rotor blade according to claim 5, wherein at least one of the vibration sensors selected from the first vibration sensor and the second vibration sensor is/are provided at a radial position in the area of the outer 80% of the radius of the rotor blade of the wind turbine.

7. The rotor blade according to claim 5, wherein the at least two strain sensors are arranged in the area of a blade root of the rotor blade.

8. A method for at least one of monitoring and controlling a wind turbine, comprising:
measuring vibrations of a rotor blade of the wind turbine in two different spatial directions, wherein the measuring of vibrations is performed by means of at least two fiber optic vibration sensors;
measuring bending moments of the rotor blade of the wind turbine in at least two different spatial directions; and
performing at least one of monitoring and controlling the wind turbine based on the vibrations in the two different spatial directions of the measurement of vibrations, and the bending moments in the at least two different spatial directions of the measurement of bending moments.

9. The method according to claim 8, wherein the measuring of vibrations comprises measuring frequency shifts of the vibrations.
